(19) United States
(12) Patent Application Publication
(10) Pub. No.: US 2026/0225236 A1
(43) Pub. Date: Aug. 6, 2026

(54) OBJECT-CENTRIC PREDICTION AND CONTROL FOR HUMAN TO ROBOT SKILL TRANSFER

(71) Applicant: Tacta Systems Inc., Palo Alto, CA (US)

(72) Inventors: Harry Zhe Su, Union City, CA (US); Darshan Hegde, San Mateo, CA (US); Qingkai Lu, Sunnyvale, CA (US); Dariusz Golda, Portola Valley, CA (US)

(21) Appl. No.: 19/042,998

(22) Filed: Jan. 31, 2025

(51) Int. Cl. B25J 9/16; B25J 13/08

(52) U.S. Cl. CPC B25J 9/163; B25J 13/081

(57) ABSTRACT

A system for training a robotic device to perform a task may include a glove to be worn by a user; a sensor array coupled to the glove, a camera to generate images of an object; and a processor configured to execute instructions stored in memory. The processor can receive contact measurements from the sensor array, including tactile signals determined from tactile sensors and positions determined from motion sensors, and an object pose of the object based on an image from the camera, a fusion of images, motion sensing, and/or the contact measurements. The processor can train a machine learning model, based on training data including the contact measurements and the object pose, to generate a prediction of future contact measurements and a future object pose. Other aspects are also described and claimed.

### BACKGROUND

### Field

This disclosure relates generally to robotic systems and, more specifically, to training robotic devices to perform tasks. Other aspects are also described.

### BACKGROUND INFORMATION

A robotic device, or robot, may refer to a machine that can automatically perform one or more actions or tasks in an environment. For example, a robotic device could be configured to assist with manufacturing, assembly, packaging, maintenance, cleaning, transportation, exploration, surgery, or safety protocols, among other things. A robotic device can include various mechanical components, such as a robotic arm and an end effector, to interact with the surrounding environment and to perform the tasks. A robotic device can also include a processor or controller executing instructions stored in memory to configure the robotic device to perform the tasks.

### SUMMARY

Implementations of this disclosure include enabling machine learning by human demonstration via a demonstration device with tactile and motion sensing and a camera so that the skills to perform many different tasks with different objects can be transferred quickly and efficiently from users to robotic devices through a multimodal fashion. A demonstration device worn by a user, such as a glove with motion sensing and tactile sensing (e.g., a sensing glove), can demonstrate a variety of tasks with objects with fine-grained and dexterous manipulation to generate training data to train a machine learning model. The tactile sensing may be multimodal tactile sensing (e.g., each sensor in the sensor array may be configured for sensing either a normal force, shear force, vibration, temperature, proximity, or image, so that a group of sensors in a sensor section can sense a plurality of conditions). The machine learning model may be trained based on contact measurements from the motion sensing and the tactile sensing, and object poses from images of the object, a fusion of images of the object, motion sensing, and/or the contact measurements, in a demonstration environment obtained while demonstrating/performing the task.

The machine learning model, in turn, may enable a robotic device that corresponds to the demonstration device, including with the motion sensing, tactile sensing, camera and control of joints, such as a robotic hand coupled to a robotic arm, to perform the various tasks with objects with the same fine-grained and dexterous manipulation that was demonstrated by the glove. The robotic hand visually corresponds to a human hand and kinematically and dynamically performs like a human hand. The robotic device may perform the tasks based on predictions from the machine learning model that are responsive to contact measurements from motion sensing and tactile sensing by the robotic device in the robotic environment, and based on object poses from images of the object in a robotic environment, a fusion of images of the object, motion sensing, and/or the contact measurements. As a result, robotic devices may be trained quickly and efficiently by human demonstration learning to obtain many different skills from human users.

Some implementations may include a system for training a robotic device to perform a task, including: a glove to be worn by a user, the glove including digits having digit sections; a sensor array coupled to the glove, the sensor array including i) multimodal tactile sensors arranged in sensor sections coupled to digit sections and ii) motion sensors coupled to digits (e.g., digit sections); a camera to generate images of an object; and a processor configured to: receive contact measurements from the sensor array, including multimodal tactile signals determined from multimodal tactile sensors and positions determined from motion sensors; receive an object pose of the object based on an image from the camera, fusion of images from the camera, and motion sensing and the contact measurements; and train a machine learning model based on training data including the contact measurements and the object pose to generate a prediction of future contact measurements and a future object pose to perform a task with the object.

Some implementations may include system for performing a task with an object, including: a robotic hand including digits having digit sections; a sensor array coupled to the robotic hand, the sensor array including i) multimodal tactile sensors arranged in sensor sections coupled to digit sections and ii) motion sensors coupled to digits (e.g., digit sections); a camera to generate images of an object; and a processor configured to: receive contact measurements from the sensor array, including multimodal tactile signals determined from multimodal tactile sensors and positions determined from motion sensors; receive an object pose of the object based on an image from the camera, a fusion of images from the camera, motion sensing, and/or the contact measurements; and generate, based on the contact measurements and the object pose, a prediction of future contact measurements and a future object pose to perform a task with the object. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure herein are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of system for training robotic devices to perform tasks.

FIG. 2 is an example of a demonstration device performing a task with an object.

FIG. 3 is an example of contact measurements from a demonstration device.

FIG. 4 is an example of an object pose based on an image from a camera, a fusion of images from the camera, motion sensing, and/or contact measurements.

FIG. 5 is an example of a robotic device performing a task with an object.

FIG. 6 is an example of contact measurements from a robotic device.

FIG. 7 is an example of generating predictions to perform a task with an object.

FIG. 8 is an example of generating predictions to perform a plurality of tasks.

FIG. 9 is an example of a process for training robotic devices to perform tasks.

FIG. 10 is an example of a process for controlling robotic devices to perform tasks.

### DETAILED DESCRIPTION

Conventional robotic devices may have difficulty performing the various fine detail work that humans can perform. For example, certain manufacturing or assembly tasks may involve precision handling of discrete components and/or fine manipulation of small tools in relation to small targets (e.g., smaller than the human hand). While humans routinely manage these tasks, robotic devices may struggle with them. As a result, robotic devices are traditionally utilized for less detailed work, such as picking and placing larger objects, manipulating larger items, and other coarse work.

Furthermore, it may be difficult to train conventional robotic devices to perform the many different tasks with different objects that humans can perform. For example, in a manufacturing environment, many different connectors, wires, and other objects may need to be picked up from certain places and installed in other places in an electrical system. These objects, and their targets, may have different shapes, sizes, colors, orientations, states, etc. that can make training for the different possibilities time consuming and difficult.

Implementations of this disclosure address problems such as these by enabling machine learning by human demonstration via a demonstration device with tactile and motion sensing and a camera so that the skills to perform many different tasks with different objects can be transferred quickly and efficiently from users to robotic devices. A demonstration device worn by a user, such as a glove with motion sensing and tactile sensing (e.g., a sensing glove), can demonstrate a variety of tasks with objects with fine-grained and dexterous manipulation to generate training data to train a machine learning model. The tactile sensing may be multimodal tactile sensing (e.g., each sensor in the sensor array may be configured for sensing either a normal force, shear force, vibration, temperature, proximity, or image, so that a group of sensors in a sensor section can sense a plurality of conditions). The machine learning model may be trained based on contact measurements from the motion sensing and the tactile sensing, and object poses from images of the object, a fusion of images of the object, the motion sensing, and/or the contact measurements, in a demonstration environment obtained while demonstrating/performing the task.

The machine learning model, in turn, may enable a robotic device that corresponds to the demonstration device, including with the motion sensing, tactile sensing, a camera and control of joints, such as a robotic hand coupled to a robotic arm, to perform the various tasks with objects with the same fine-grained and dexterous manipulation that was demonstrated by the glove. The robotic hand may visually correspond to a human hand and may kinematically and dynamically perform like a human hand. For example, the robotic hand may be configured to match a plurality of features of a human hand, including a range of motion corresponding to each joint, a maximum amount of force or pressure that may be applied between digits, a velocity in which the robotic hand can move, and an amount of compliance (e.g., flexibility of each joint and/or soft finger pads, such as when grasping an object, to prevent breakage). The robotic device may perform the tasks based on predictions from the machine learning model that are responsive to contact measurements from motion sensing and tactile sensing by the robotic device in the robotic environment, and based on object poses from images of the object in a robotic environment, a fusion of images of the object, the motion sensing, and/or the contact measurements. As a result, robotic devices may be trained quickly and efficiently by human demonstration learning to obtain many different skills from human users.

In some implementations, a system may perform human/skill transfer learning by 1) collecting large scale (in the wild) human demonstration data from one or more of time-synchronized cameras, digit/arm pose motion sensors/trackers, and force/tactile sensing gloves; 2) extracting object poses through object segmentation and pose estimation from images; 3) extracting contact measurements from positions and force vectors in the object frame of reference from human demonstrations; 4) training an object-centric contact prediction model (e.g., the machine learning model) based on data extracted from step 2 and step 3; 5) during online execution, the robotic device used by the machine learning model to predict future/target object 6D poses and future/target contact measurements including positions and force vectors in the object frame of reference; and 6) the robotic device using a contact control policy to achieve predicted object 6D poses and contacts positions and force vectors (e.g., controlling actuators to drive joints of the robotic hand and the robotic arm).

For example, a user wearing a demonstration device (e.g., the sensing glove) can demonstrate a task with an object, such as grasping an electrical connector and installing it at a target in an electrical system. As the user contacts the object with at least two digits through the sections of the sensor array, a force distribution (tactile map) at each of a plurality of time stamps may be generated and recorded for the duration of the task, including while holding and inserting the object in a target. Camera images and digit positions of the user versus time may also be received and time-synchronized to the force distributions. As the user contacts the object, object poses may be determined by a pose estimation algorithm. Contact measurements, including 3D force vectors and 3D positions of tactile sensors and forces within the M×N sensor array may be represented as a 6×M×N array of measurements in an object frame of reference. To train the machine learning model, a current object pose, image, and contact measurements from the sensor array may be input to the model. Future/target object poses in a 1×7 array, 1×3 for positions and 1×4 for orientation represented in a quaternion orientation representation (e.g., quaternions), and 6×M×N array of contact measurements (e.g., 3D positions and 3D force vectors), may be generated by the machine learning model as outputs (predictions). The trained model can then be deployed to one or many robotic devices to predict future/target object poses and future/target contact measurements to perform the tasks.

In some implementations, time based inputs to the machine learning model may include a) raw, tactile data from the sensor array (e.g., forces), b) digit and arm positions of the user (e.g., positions), c) point clouds, d) 6D object poses, e) 3D force vectors (determined from tactile sensors), f) 3D positions for the tactile sensor array in the object frame of reference (determined from motion sensors). One or more of the foregoing signals may be received and recorded for an entirety of a task.

In some implementations, the robotic device can use one or more contact control policies, such as a model based whole body control framework, such as operational space control, or a trajectory optimization framework, to adjust digit poses (or joint angles) and robotic arm poses (or joint angles) based on predicted future/target object poses and future/target contact measurements (e.g., forces and positions). A learning based contact control policy can also be trained on successful task executions using model based whole body control or trajectory optimization. A learning based contact control policy can also be further refined based on supervised learning, interactive imitation learning, or reinforcement learning.

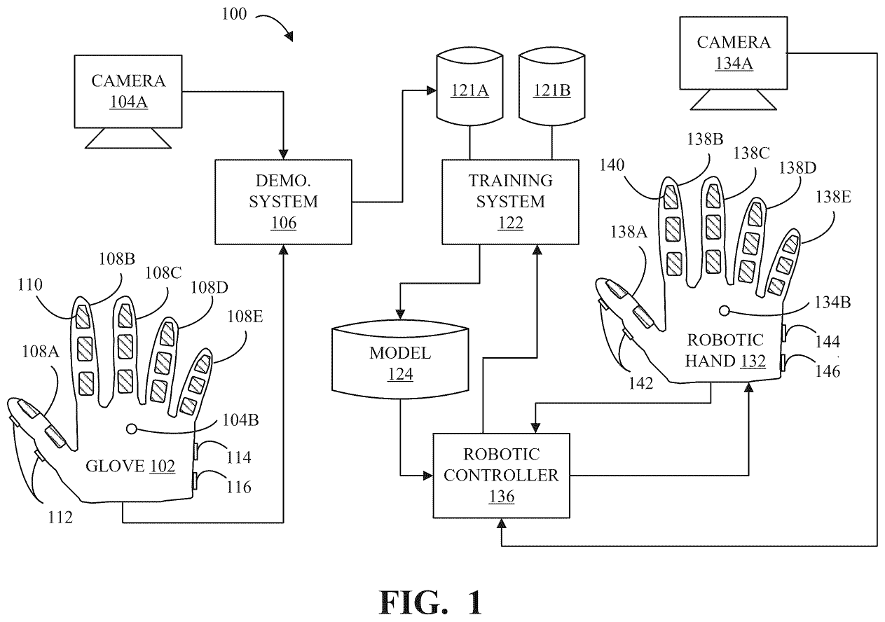

FIG. 1 is an example of system 100 for training robotic devices to perform tasks. The system 100 may enable machine learning by human demonstration via a demonstration device with tactile and motion sensing and a camera so that the skills to perform many different tasks with different objects can be transferred quickly and efficiently from users to robotic devices. The system 100 may include a demonstration device to be worn by a user in a demonstration environment, such as a glove 102 with motion sensing and tactile sensing (e.g., a sensing glove), a demonstration camera, such as a scene camera 104A in the environment and/or a sensing camera 104B coupled to the glove 102, and a demonstration system 106 (e.g., readout circuitry, a processor, a communications device, and/or demonstration data collection software).

The glove 102 may include digits, such as digits 108A, 108B, 108C, 108D, and 108E corresponding to a thumb and four fingers (e.g., five digits), respectively. The digits may include flexible areas for joints of the user, such as metacarpophalangeal (MCP), distal interphalangeal (DIP), and proximal interphalangeal (PIP) joints. The digits 108A-108E may include digit sections between the tips and joints of the digits (e.g., two digit sections per thumb, and three digit sections per finger).

The glove 102 may also include a sensor array coupled thereto. The sensor array may include i) tactile sensors arranged in sensor sections 110 coupled to digit sections of digits (e.g., palmar side of digits), and ii) motion sensors 112 coupled to digits of digits (e.g., one or more motion sensors per sensor section 110, dorsal side of digits). The sensor sections 110 may comprise tactile arrays, or contact patches, coupled with the digit sections. For example, digit 108A may be a thumb with two sensor sections 110 between the tip and two joints, and digits 108B-108E may be fingers with three sensor sections 110 between the tip and three joints each. Each sensor section 110 may enable tactile sensing similar to human sensing. For example, each sensor section 110 may include a plurality of sensors 120 (e.g., tactile sensors) arranged in a grid, or rows and columns. A sensor 120 may be submillimeter in at least one in-plane dimension (e.g., a dimension of its footprint), to obtain a high spatial resolution measurements that are less than 2 millimeters (mm) apart, and in some cases, less than 1 mm apart. The sensors 120 may enable single mode or multimodal tactile sensing in a sensor section 110. For example, each sensor 120 may be configured for sensing either a normal force, shear force, vibration, temperature, proximity, or image, operating as a force sensor, vibration sensor, temperature sensor, proximity sensor, and/or image sensor, respectively, so that a group of sensors in a sensor section 110 (single or multimodal) can sense one or more conditions based on contact with objects. Each sensor 120 may comprise, for example, piezoelectric elements (e.g., for sensing the normal force, shear force, vibration, temperature, or proximity, as configured), photo sensitive circuitry (e.g., for sensing the image), and/or digital readout circuitry to send tactile signals (e.g., a charge amplifier, transistors, and/or buffering, indicating the multimodal sensing). Each motion sensor 112 may comprise, for example, a multi-axis inertial measurement unit (IMU) or other motion sensing device, corresponding to tactile sensors in a sensor section 110.

The sensor array may periodically generate digital outputs with time stamps to indicate contact measurements with objects, if any. The contact measurements may be represented by a force distribution in the sensor array (M×N sensors). For example, the contact measurements may include forces determined from tactile sensors of the sensor sections 110. The forces may include 3D force vectors corresponding to contact between sensor sections and the object. Each force may indicate an amount of force from a sensor, expressed by a 3D force vector corresponding to contact between the sensor and the object. In some cases, the forces may be aggregated to indicate an amount of force from an entire sensor section 110, expressed by a 3D force vector corresponding to contact between the sensor section and the object. The contact measurements may also include positions determined from the motion sensors 112. The positions may indicate 3D positions of the forces corresponding to contact between the sensors and/or sensor sections and the object.

The glove 102 may also include one or more inputs 114, such as a button and/or a microphone. The one or more inputs 114 may be used, for example, to receive commands from the user, such as to indicate a start or end of a task, an indication of a type of task, or an input indicating a standard operating procedure for a task. In some cases, the one or more inputs 114 may be used to detect audio input associated with a task. The glove 102 may also include one or more outputs 116, such light emitting diode, display, or haptic feedback. The one or more outputs 116 may be used, for example, to provide feedback to the user.

The demonstration camera (e.g., the scene camera 104A and/or the sensing camera 104B) may generate images of an object in the demonstration environment with corresponding time stamps. The images may enable the demonstration system 106 to determine object poses of objects in the demonstration environment, timed with the contact measurements from the sensor array. For example, an object pose may indicate a 3D position and 3D orientation of an object relative to the environment of the object. In some cases, the object pose may be determined based on a segmentation of the object from the image (e.g., extracting an object pose through object segmentation and pose estimation from the image). In some cases, the object pose may be determined based on a point cloud generated by an RGB-D image from the demonstration camera. In some cases, multiple cameras may be used to determine the object pose (e.g., the scene camera 104A and the sensing camera 104B operating jointly). This may enable a more accurate estimation of object poses, regardless of occlusion of the object in an image (e.g., by digits of the glove 102). In some cases, motion sensing and the tactile sensing may be used to determine the object poses (e.g., via the motion sensors 112 and sensor sections 110) during occlusion of the object in one or more images from the one or more cameras (e.g., a complete occlusion of the object). In some cases, motion sensing and tactile sensing may be fused with one or more images from one or more cameras during occlusion of the object in images from the one or more cameras (e.g., a partial occlusion of the object).

The demonstration system 106 may be coupled to the glove 102. In some cases, the demonstration system 106 may be implemented by a separate device (e.g., off system). The demonstration system 106 may include one or more processors configured to execute instructions stored in memory, I/O coupled to the sensor array and the demonstration camera, a communications interface (wireless), and/or a power supply (wireless). The demonstration system 106 may receive digital inputs from sensing, including contact measurements from the sensory array (e.g., forces from tactile sensors of the sensor sections 110, and positions from the motion sensors 112) and images from the demonstration camera (e.g., the scene camera 104A and/or the sensing camera 104B).

The glove 102 may be worn by a user to demonstrate a task with an object in the demonstration environment. The task may be performed by the user, along with other tasks, objects, and targets, including other users and other gloves 102. The task may be performed with fine-grained and dexterous manipulation to generate large scale (in the wild) human demonstration data 121A (e.g., skills to perform many different tasks with different objects).

A training system 122 may extract and/or label features of the demonstration data 121A corresponding to various tasks to generate training data 121B for training an object-centric contact prediction model, such as a machine learning model 124. The training data 121B may include a plurality of data samples, corresponding to a plurality of time stamps, for tasks given by human demonstration. Each data sample may include contact measurements from a glove 102 and an object pose from a demonstration camera (e.g., the scene camera 104A and/or the sensing camera 104B) corresponding to a time stamp for one or more tasks with one or more objects. The training system 122 may train the machine learning model 124 to generate predictions based on the training data 121B. In some cases, the machine learning model 124 may be trained to generate a trajectory of poses for an object based on a plurality of predictions corresponding to a plurality of future time stamps.

A prediction from the machine learning model may include future contact measurements and a future object pose to perform a task with an object. The prediction may enable a robotic device to control movements of one or more of the digits of a robotic hand (e.g., an end effector) and/or a robotic arm coupled thereto to achieve a position, orientation, and/or applied force to cause the future contact measurements and the future object pose to perform the task. To make a prediction, the machine learning model 124 may be trained using historical information from the training data 121B, such as historical contact measurements and object poses, corresponding to frames or time stamps, for a given task. The training data 121B can enable the machine learning model 124 to learn patterns, such as temporal patterns that maintain a correlation of input motions (e.g., movements of digits and arms) to measured forces and positions and object poses. The training data 121B may derive from multiple tasks (e.g., traversing, retrieving, approaching, grasping, withdrawing, orienting, perceiving, manipulating, securing, installing, or inserting) performed with multiple objects (e.g., components, wires, fasteners, tools, etc.). In some cases, the training data 121B may be specific to a single task and/or object (e.g., grasping an electrical connector and installing it at a target in an electrical system). The training data 121B may omit certain data samples that are determined to be outliers, such as extensive motions of the glove 102 and/or training with defective objects. The machine learning model 124 may, for example, be or include one or more of a neural network (e.g., a transformers neural network, a convolutional neural network (CNN), recurrent neural network (RNN), deep neural network (DNN), or other neural network), decision tree, vector machine, Bayesian network, cluster-based system, genetic algorithm, deep learning system separate from a neural network, physics-based model, or other machine learning model.

The system 100 may include a robotic device or machine in a robotic environment, such as a robotic hand 132 with motion sensing and tactile sensing (e.g., a sensing hand) coupled to a robotic arm, a robotic camera, such as a scene camera 134A in the environment and/or a sensing camera 134B coupled to the robotic hand 132, and a robotic controller 136. The robotic hand 132 may correspond to the glove 102, may be visually like a human hand, and may perform kinematically and dynamically like a human hand. The robotic hand 132 may also include motion sensing and tactile sensing and control of joints to perform the various tasks with objects, including with the same fine-grained and dexterous manipulation that was demonstrated by the glove 102. The robotic hand 132 may perform the tasks based on predictions from the machine learning model 124 that are responsive to contact measurements from motion sensing and tactile sensing by the robotic hand 132 in the robotic environment, and based on object poses from images of the object in a robotic environment. The predictions may be generated at time stamps with a same frequency as the frequency for receiving contact measurements and objects at time stamps (e.g., at a rate of 100 Hz or more).

The robotic hand 132 may include digits, such as digits 138A, 138B, 138C, 138D, and 138E corresponding to a thumb and four fingers (e.g., five digits), respectively. The digits may include joints that move at joint angles to achieve various degrees of freedom (DOF), such as MCP, DIP, and PIP joints providing multiple DOF. The robotic hand 132 may be further coupled with a robotic arm that also includes joints that move at angles to achieve further DOF. The digits 138A-138E may include digit sections between the tips and joints of the digits (e.g., two digit sections per thumb, and three digit sections per finger).

The robotic hand 132 may also include a sensor array coupled thereto, corresponding to the sensor array coupled to the glove 102. The sensor array may include i) tactile sensors arranged in sensor sections 140 coupled to digit sections of digits (e.g., palmar side of digits), and ii) motion sensors 142 coupled to digits of digits (e.g., one or more motion sensors per sensor section 140, arranged inside of digits). The sensor sections 140 may comprise tactile arrays, or contact patches, coupled with the digit sections. For example, digit 138A may be a thumb with two sensor sections 140 between the tip and two joints, and digits 138B-138E may be fingers with three sensor sections 140 between the tip and three joints each. Like sensor section 110, each sensor section 140 may enable tactile sensing similar to human sensing. For example, each sensor section 140 may include a plurality of sensors 120 (e.g., tactile sensors) arranged in a grid, or rows and columns. A sensor 120 may be submillimeter in at least one in-plane dimension (e.g., a dimension of its footprint), to obtain a high spatial resolution measurements that are less than 2 millimeters (mm) apart, and in some cases, less than 1 mm apart. The sensors 120 may enable single mode or multimodal tactile sensing in a sensor section 140. For example, each sensor 120 may be configured for sensing either a normal force, shear force, vibration, temperature, proximity, or image, operating as a force sensor, vibration sensor, temperature sensor, proximity sensor, and/or image sensor, respectively, so that a group of sensors in a sensor section 140 (single or multimodal) can sense one or more conditions based on contact with objects. Each sensor 120 may include, for example, a piezoelectric element (e.g., for sensing the normal force, shear force, vibration, temperature, or proximity, as configured), photo sensitive element (e.g., for sensing the image), and/or digital readout circuitry to send tactile signals (e.g., a charge amplifier, transistors, and/or buffering, indicating the multimodal sensing). Each motion sensor 142 may comprise, for example, a joint position encoder or other motions sensing device and/or a joint torque sensor or other force/torque sensing device corresponding to the tactile sensing indicated by the tactile signals from the tactile sensors. Each motion sensor 142 may be kinematically coupled to a global position of the sensor array to enable determining positions of the tactile sensing (e.g., determining 3D positions of 1D forces or 3D force vectors corresponding to contact between sensor sections 140 and an object).

The sensor array may periodically generate digital outputs with time stamps to indicate contact measurements with objects, if any. The contact measurements may represent a force distribution in the sensor array. The contact measurements may include forces determined from tactile sensors of the sensor sections 140. The forces may include 3D force vectors corresponding to contact between sensor sections and the object. Each force may indicate an amount of force from a sensor, expressed by a 3D force vector corresponding to contact between the sensor and the object. In some cases, the forces may be aggregated to indicate an amount of force from a sensor section 140, expressed by a 3D force vector corresponding to contact between the sensor section and the object. The contact measurements may also include positions determined from the motion sensors 142. The positions may indicate 3D positions of the forces corresponding to contact between the sensors and/or sensor sections and the object.

The robotic hand 132 may also include one or more inputs 144, such as a button and/or a microphone. The one or more inputs 144 may be used, for example, to receive commands from a user, such as to indicate a task to be performed, to start the task, to end the task, to indicate the type of task, or to indicate a standard operating procedure for the task. In some cases, the one or more inputs 144 may be used to detect audio inputs associated with a task, e.g., to correctly perform the task, such as detecting a particular sound at a given time stamp (e.g., a component clicking/snapping into a connector). The robotic hand 132 may also include one or more outputs 146, such light emitting diode or display.

The robotic camera (e.g., the scene camera 134A and/or the sensing camera 134B) may generate images of an object in the robotic environment. The images may enable the robotic controller 136, based on predictions from the machine learning model 124, to determine object poses of objects in the robotic environment. An object pose may indicate a 3D position and 3D orientation of an object relative to the environment of the object (e.g., a marker in the robotic environment). In some cases, the object pose may be determined based on a segmentation of the object from the image (e.g., extracting object poses through object segmentation and pose estimation from the images). In some cases, the object pose may be determined based on a point cloud generated by an RGB-D image from the robotic camera. In some cases, multiple cameras may be used to determine the object pose (e.g., the scene camera 134A and the sensing camera 134B operating jointly). This may enable a more accurate estimation of object poses, regardless of occlusion of the object in an image (e.g., by digits of the glove 102). In some cases, motion sensing and the tactile sensing may be used to determine the object poses (e.g., via the motion sensors 112 and sensor section 110) during occlusion of the object in one or more images from the one or more cameras (e.g., a complete occlusion of the object). In some cases, motion sensing and tactile sensing may be fused with one or more images from one or more cameras during occlusion of the object in images from the one or more cameras (e.g., a partial occlusion of the object).

The robotic controller 136 may be coupled to the robotic hand 132. In some cases, the robotic controller 136 may be implemented by a separate device (e.g., off robot). The robotic controller 136 may include one or more processors configured to execute instructions stored in memory, I/O coupled to the sensor array and the robotic camera, a communications interface (wireless), and/or a power supply (wireless). The robotic controller 136 may receive digital inputs from sensing, including contact measurements from the sensory array (e.g., forces from tactile sensors of the sensor sections 140, and positions from the motion sensors 142) and images from the robotic camera (e.g., the scene camera 134A and/or the sensing camera 134B).

The robotic hand 132 may be controlled by the robotic controller 136 to perform tasks, such as picking up or grasping a component, e.g., an electrical connector, and installing it at a target in an electrical system. To perform the tasks, the robotic controller 136 can utilize a contact control policy to output commands that control actuators to drive joints of the robotic hand 132 and the robotic arm to positions based on the predictions. For example, the robotic controller 136 can control actuators to drive the MCP, DIP, and PIP joints of the robotic hand 132, and additional joints of the robotic arm, to move to positions based on predictions with multiple DOF.

The robotic hand 132 may be utilized to replicate one of a plurality of tasks stored in a data structure based on predictions from the machine learning model 124. To perform a selected task, the robotic controller 136 can receive a data sample from the robotic environment. Each data sample may include contact measurements from the robotic hand 132 and an object pose from the robotic camera (e.g., the scene camera 134A and/or the sensing camera 134B) corresponding to a time stamp. The robotic controller 136 can then utilize the machine learning model 124 to generate, based on the contact measurements and the object pose, a prediction of future contact measurements and a future object pose to perform the task with the object. In some cases, the robotic controller 136 can utilize the machine learning model 124 to generate a trajectory of poses for an object based on a plurality of predictions corresponding to a plurality of future time stamps. In some cases, the robotic controller 136 may provide feedback to the training system 122, which may be used to update the machine learning model 124. As a result, robotic devices like the robotic hand 132 may be trained quickly and efficiently by human demonstration learning to obtain many different skills from human users.

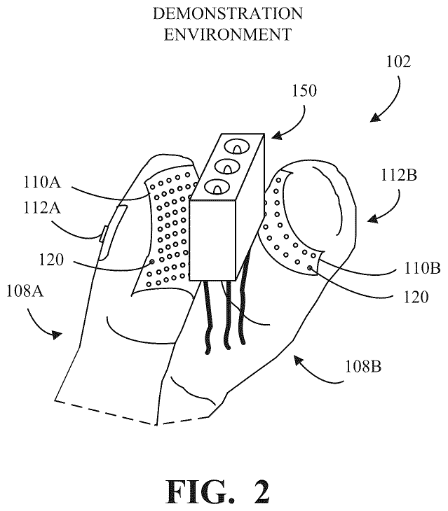

By way of example, FIG. 2 illustrates a portion of the glove 102 utilized by a user to perform a task with an object 150 (e.g., portions of two digits shown in a demonstration environment). For example, the task may comprise grasping the object 150, e.g., an electrical connector, and installing the object 150 in an electrical system. The user may utilize a thumb and finger of the glove 102 to grasp the object, such as digits 108A and 108B. Each digit may include one or more sensor sections that contact the object 150, such as sensor sections 110A and 110B coupled to digit sections of digits 108A and 108B, respectively. The sensor sections may each include tactile sensors 120 arranged in tactile arrays, such as sensor section 110A including an N1×M1 array of tactile sensors 120, and sensor section 110B including an N2×M2 array of tactile sensors 120. Each digit may also include one or more motion sensors that move with corresponding sensor sections that contact the object 150, such as motion sensor 112A coupled to digit 108A (corresponding to the sensor section 110A), and a motion sensor 112B coupled to digit 108B.

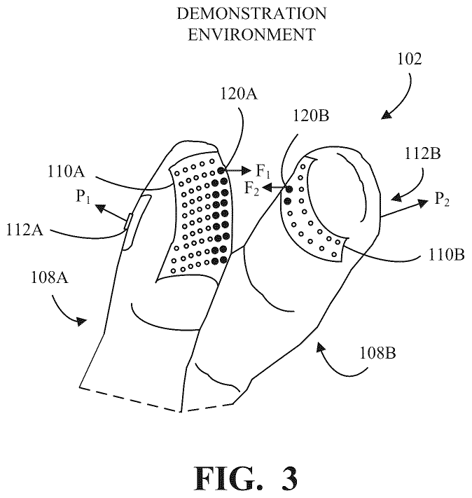

With additional reference to FIG. 3, the demonstration system 106 can receive contact measurements associated with the task from the sensor array coupled to the glove 102.

For example, the demonstration system 106 can receive forces determined from the tactile sensors, such as force F₁ determined from tactile sensor 120A (e.g., a first tactile sensor being a force sensor detecting a normal force and/or a shear force) of sensor section 110A, force F₂ determined from tactile sensor 120B of sensor section 110B (e.g., a second tactile sensor being a force sensor detecting a normal force and/or a shear force) (e.g., individual sensors highlighted to illustrate activation based on contact). The forces F₁ and F₂ may each indicate a 3D force vector corresponding to contact between the sensor in the sensor section and the object 150. The demonstration system 106 can also receive positions determined from the motion sensors, such as position P₁ determined from the motion sensor 112A coupled to digit 108A (corresponding to the sensor section 110A), and position P2 determined from the motion sensor 112B coupled to digit 108B (corresponding to the sensor section 110B). The positions P₁ and P₂ may each indicate a 3D position of a force corresponding to contact between the sensor in the sensor section and the object 150. The contact measurements may correspond to a data sample having a time stamp in the demonstration environment.

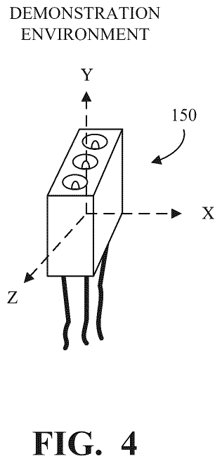

With additional reference to FIG. 4, the demonstration system 106 can also receive an object pose of the object 150 (e.g., Cartesian coordinate orientation shown by way of example) based on an image from the demonstration camera, such as the scene camera 104A and/or the sensing camera 104B. The object pose may indicate a 3D position and 3D orientation of the object 150 relative to the environment of the object (e.g., a marker in the demonstration environment). For example, the demonstration system 106 may determine the object pose of the object 150 based on a segmentation of the object from the image (e.g., extracting the object pose through object segmentation and a pose estimation from an image). In another example, the demonstration system 106 may determine the object pose of the object 150 based on a point cloud generated by an RGB-D image from the demonstration camera. In another example, the demonstration system 106 may determine the object pose of the object 150 based on contact points generated by the motion sensors 112 and associated sensor sections 110. In another example, the demonstration system 106 may determine the object pose of the object 150 by fusing the contact points generated by the motion sensors 112 and associated sensor sections 110 and the point cloud generated by an RGB-D image from the demonstration camera. The object pose may correspond to a same data sample having the same time stamp as the contact measurements (e.g., FIG. 3) in the demonstration environment.

The demonstration system 106 may receive a plurality of data samples during performance of the task with each data sample including a time stamp. Each data sample may include contact measurements and an object pose as described above in FIGS. 3 and 4 while the object 150 is manipulated and controlled by the user to perform the task. The data samples may be added to the demonstration data 121A. The training system 122 may extract and/or label features of the demonstration data 121A corresponding to various tasks, including the task to grasp the object 150 and install it in the electrical system, to generate the training data 121B. The training system 122 may utilize the training data 121B, including the contact measurements and the object pose of FIGS. 3 and 4, respectively, to train the machine learning model 124 to generate predictions to perform the task. When deployed to a robotic device, such as the robotic hand 132, the machine learning model 124 can then utilize the model to generate, based on contact measurements from its own sensor array (e.g., forces determined from sensors 120 in sensor sections 140, and positions determined from the motion sensors 142) and an object pose from a robotic camera (e.g., the scene camera 134A and/or the sensing camera 134B), a prediction of future contact measurements and a future object pose to perform the task with the object, e.g., grasp the object 150 and install it in an electrical system. The robotic controller 136 can then control digits of the robotic hand, e.g., digits 138A and 138B, to move to a position and an orientation based on the prediction from the machine learning model 124 to perform the task.

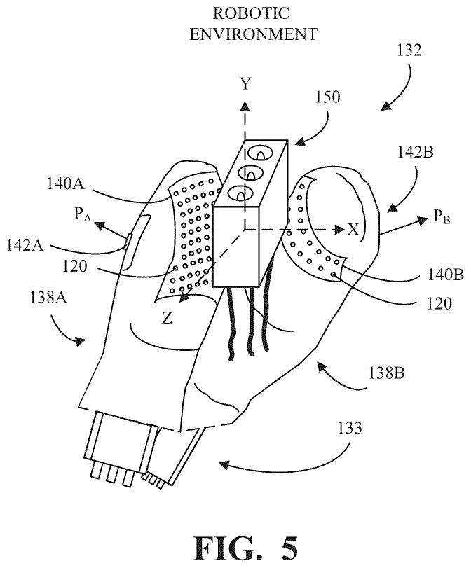

For example, FIG. 5 illustrates a portion of the robotic hand 132, including robotic circuitry 133, utilized by a machine to perform a task with an object 150 (e.g., portions of two digits shown in a robotic environment). For example, the task may comprise grasping the object 150, e.g., the connector, and installing the object 150 in an electrical system. The robotic hand 132 may utilize a thumb and finger to grasp the object, such as digits 138A and 138B. Each digit may include one or more sensor sections that contact the object 150, such as sensor sections 140A and 140B coupled to digit sections of digits 138A and 138B, respectively. The sensor sections may include tactile sensors 120 arranged in tactile arrays, such as sensor section 140A including an N1×M1 array of tactile sensors 120, and sensor section 140B including an N2×M2 array of tactile sensors 120. Each digit may also include one or more motion sensors that move with corresponding sensor sections that contact the object 150, such as motion sensor 142A coupled to digit 138A (corresponding to the sensor section 140A), and a motion sensor 142B coupled to digit 138B.

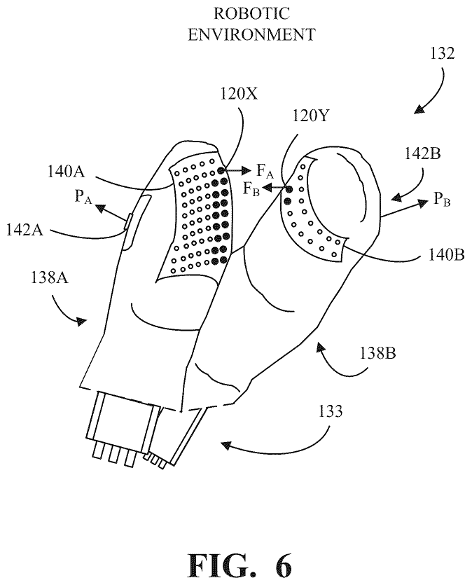

With additional reference to FIG. 6, the robotic controller 136 can receive contact measurements associated with the task from the sensor array coupled to the robotic hand 132. For example, the robotic controller 136 can receive forces determined from the tactile sensors, such as force F_{A} determined from tactile sensor 120X of sensor section 140A (e.g., a first tactile sensor being a force sensor detecting a normal force and/or a shear force), force F_{B} determined from tactile sensor 120Y of sensor section 140B (e.g., a second tactile sensor being a force sensor detecting a normal force and/or a shear force) (e.g., individual sensors highlighted to illustrate activation based on contact). The forces F_{A} and F_{B} may each indicate a 3D force vector corresponding to contact between the sensor in the sensor section and the object 150. The robotic controller 136 can also receive positions determined from the motion sensors, such as position P_{A} determined from the motion sensor 142A coupled to digit 108A (corresponding to the sensor section 110A), and position P_{B} determined from the motion sensor 142B coupled to digit 108B (corresponding to the sensor section 110B). The positions P_{A} and P_{B} may each indicate a 3D position of a force corresponding to contact between the sensor in the sensor section and the object 150. The contact measurements may correspond to a data sample having a time stamp in the robotic environment.

Referring again to FIG. 5, the robotic controller 136 can receive an object pose of the object 150 (e.g., Cartesian coordinate orientation shown) based on an image from the robotic camera, such as the scene camera 134A and/or the sensing camera 134B. The object pose may indicate a 3D position and a 3D orientation of the object 150 relative to the environment of the object (e.g., a marker in the robotic environment). For example, the robotic controller 136 may determine the object pose of the object 150 based on a segmentation of the object from the image (e.g., extracting the object pose through object segmentation and a pose estimation from an image). In another example, the robotic controller 136 may determine the object pose of the object 150 based on a point cloud generated by an RGB-D image from the robotic camera. The object pose may correspond to a data sample having the same time stamp as the contact measurements (e.g., FIG. 5) in the robotic environment. The robotic controller 136 may generate, based on the contact measurements (e.g., the forces F_{A} and F_{B} and the positions P_{A} and P_{B}) and the object pose, a prediction of future contact measurements and a future object pose to perform the task with the object 150. Further, the robotic controller 136 may continuously update predictions based on updated contact measurements and updated object poses that may be received until the task is completed.

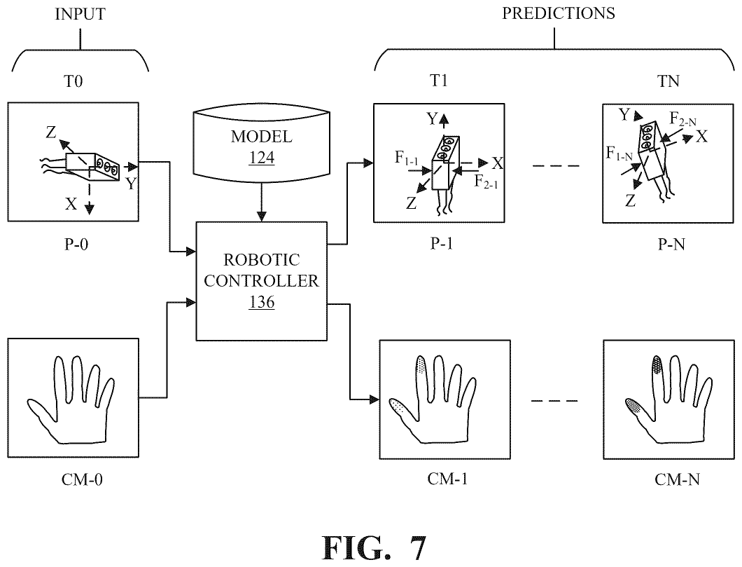

FIG. 7 is an example of generating predictions to perform a task with an object, such as grasping the object 150 (e.g., the connector) and installing it at a target in an electrical system. At a time TO, the robotic controller 136 can receive contact measurements CM-0 from the sensor array, including forces determined from tactile sensors and positions determined from motion sensors. For example, the contact measurements CM-0 may indicate that the robotic hand 132 has not yet contacted the object 150 (e.g., the force distribution may indicate only baseline measurements, such as all zeros). Also, at the time T0, the robotic controller 136 can receive an object pose P-0 of the object based on an image from the robotic camera. For example, the object pose P-0 may indicate that the object 150 is oriented flat at a corner of a workbench in the environment (e.g., in a parts bin).

The robotic controller 136 may then generate, based on the contact measurements CM-0 and the object pose P-0 at time T0, a prediction of future contact measurements CM-1 and a future object pose P-1 at a future time T1 to perform the task with the object (e.g., grasping the object and installing it at a target in the system). The prediction may replicate an action of the task as trained by the glove 102. In some cases, the robotic controller 136 may generate a trajectory of poses for the object 150 based on a plurality of predictions corresponding to a plurality of future time stamps. For example, the robotic controller 136 may generate predictions of future contact measurements and future object poses at N future time stamps where N is an integer greater than one. This may enable a trajectory of poses of the object 150 to be determined for performance of the task. The robotic controller 136 may then control one or more joints of the robotic hand 132 (digits) and/or robotic arm coupled thereto, via the robotic circuitry 133, accordingly at each time stamp, based on each prediction, to move to a position and an orientation based on the prediction to perform the task. For example, the robotic circuitry 133 may include actuators to drive the MCP, DIP, and PIP joints of the robotic hand 132, and additional joints of the robotic arm.

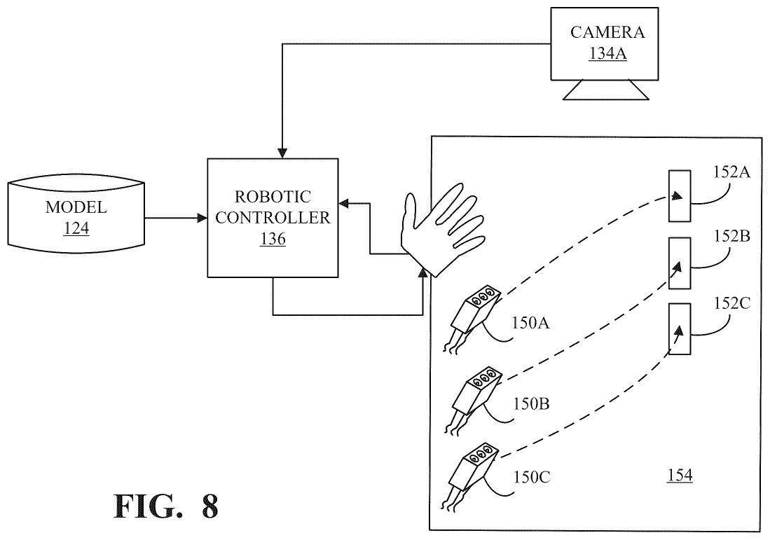

FIG. 8 is an example of generating predictions to perform a plurality of tasks with a plurality of objects, such as grasping objects 150A, 150B, and 150C (e.g., different electrical connectors) and installing them at targets 152A, 152B, and 152C to build an electrical system 154. The robotic controller 136 may initially receive contact measurements and an object pose of object 150A. The robotic controller 136 may then generate one or more first predictions via the machine learning model 124 to perform a first task with object 150A, e.g., grasping object 150A and installing it at target 152A. The robotic controller 136 may then receive contact measurements and an object pose of object 150B and generate one or more second predictions via the machine learning model 124 to perform a second task with object 150B, e.g., grasping object 150B and installing it at target 152C, and so forth. The robotic controller 136 may repeat tasks in this manner until the tasks are complete and the electrical system 154 is built.

While this example illustrates the same task being repeated, the robotic controller 136 can sequentially perform different tasks with different objects to build the electrical system 154, e.g., install connector, thread wire, drive screw, etc. Furthermore, while this example illustrates the robotic controller 136 utilizing one robotic hand to perform multiple tasks, in various implementations one or more robotic controllers may be utilized to control multiple robotic hands. For example, the multiple robotic hands may be controlled to work together to perform the task (e.g., left, and right hands) or to simultaneously perform different tasks (e.g., different stations of an assembly line).

Reference is now made to flowcharts of examples of processes for training robotic devices to perform tasks. The processes can be executed using computing devices, such as the systems, hardware, and software described with respect to FIGS. 1-8. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

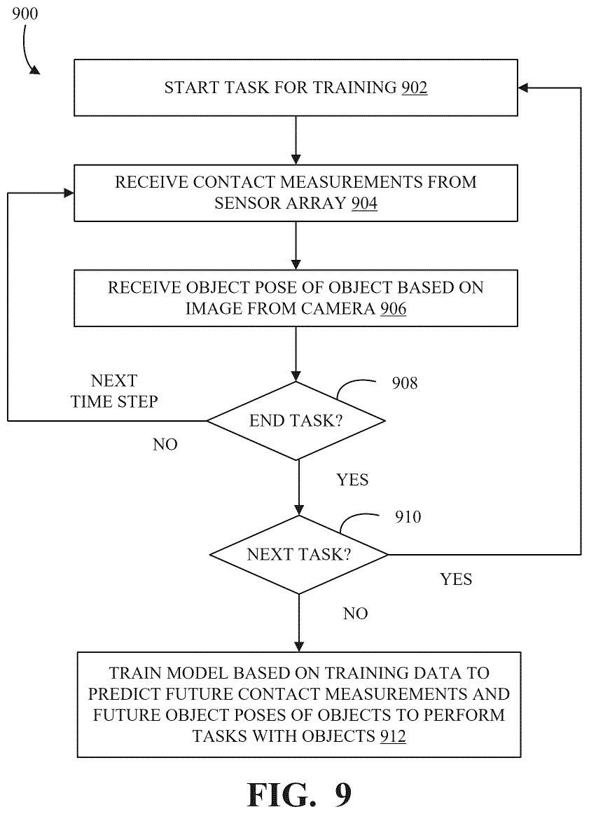

FIG. 9 is an example of a process 900 for training robotic devices to perform tasks. At operation 902, a system (e.g., the glove 102, operated by the user, and controlled via the demonstration system 106) can start a task for training in a demonstration environment, such as grasping an electrical connector and installing it at a target in an electrical system. This may include a user donning the glove 102 and giving a command to start the task, such as via the one or more inputs 114 (e.g., the microphone). In some cases, the user may give the command to start the task via a first predefined hand gesture detected by the motion sensors. The system can receive the command from the user indicating a start of the task.

At operation 904, the system may receive contact measurements from a sensor array coupled to the glove 102, including tactile signals from tactile sensors (e.g., forces, such as normal forces or shear forces, vibrations, temperatures, proximities, or images, corresponding to the multimodal sensing) determined from tactile sensors and positions determined from motion sensors. The contact measurements may correspond to a data sample having a time stamp in the demonstration environment.

At operation 906, the system may receive an object pose of the object based on an image from the camera (e.g., the demonstration camera, such as the scene camera 104A and/or the sensing camera 104B). In some implementations, the system may receive an object pose of the object (an object pose) based on a fusion of images of the object, motion sensing, contact measurements, and/or a combination thereof. The object pose may also correspond to the same data sample having the time stamp in the demonstration environment.

At operation 908, the system may determine whether the task has ended. In some cases, the system can determine that the task has ended by receiving a command from the user indicating the end of the task. For example, the user may give a command to end the task via the one or more inputs 114 (e.g., the microphone). In some cases, the user may give the command to end the task via a second predefined hand gesture detected by the motion sensors. If the task has not ended (No), the process can return to operations 904 and 906 to receive a next data sample corresponding to a next time stamp.

However, if the task has ended (Yes), the process can continue to operation 910 to determine whether a next task will be performed. For example, the user may give a command to record a next task via the one or more inputs 114 (e.g., the microphone). In some cases, the user may give the command to record the next task via a third predefined hand gesture detected by the motion sensors. In this way, the user may collect the demonstration data 121A for a plurality of tasks and/or using a plurality of objects. If a next task will be performed (Yes), the process can return to operation 902 to start the next task, then operations 904 and 906 to receive a data sample corresponding to a time stamp for the next task.

However, if a next task will not be performed (No), the process can continue to operation 912 to train a machine learning model (e.g., an object-centric contact prediction model, such as a machine learning model 124) based on training data (e.g., training data 121B, extracted from the demonstration data 121A, including the contact measurements and the object poses corresponding to the different tasks) to generate a prediction of future contact measurements and future object poses to perform the one or more tasks that may have been recorded.

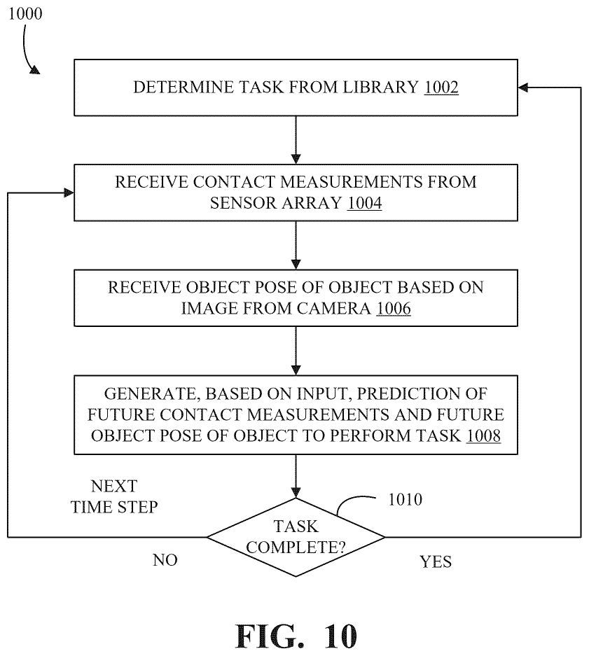

FIG. 10 is an example of a process 1000 for controlling robotic devices to perform tasks. At operation 1002, a system (e.g., the robotic hand 132, visually and kinematically corresponding to a human hand, controlled via the robotic controller 136) can determine a task from a data structure or library, including a plurality of tasks, to perform with an object in a robotic environment. For example, the task may include grasping an electrical connector (e.g., the object 150) and installing it at a target in an electrical system (e.g., a target). In some cases, the system may receive a command that indicates the task to perform, such as via the one or more inputs 144 (e.g., the microphone). In some cases, the system may predict the task to perform, such as via the machine learning model 124.

At operation 1004, the system may receive contact measurements from the sensor array (e.g., coupled to the robotic hand 132), including tactile signals from tactile sensors (e.g., forces, such as normal forces or shear forces, vibrations, temperatures, proximities, or images, corresponding to the multimodal sensing) determined from tactile sensors and positions determined from motion sensors. The contact measurements may correspond to a data sample having a time stamp in the robotic environment.

At operation 1006, the system may receive an object pose of the object based on an image from the camera (e.g., the robotic camera, such as the scene camera 134A and/or the sensing camera 134B). The object pose may also correspond to the same data sample having the same time stamp in the robotic environment.

At operation 1008, the system may generate, based on the contact measurements and the object pose, a prediction of future contact measurements and a future object pose to perform a task with the object. The system may generate the prediction for a future time stamp. The prediction may replicate an action of the task stored in the data structure. In some cases, the system may generate a trajectory of poses for the object based on a plurality of predictions corresponding to a plurality of future time stamps. Performing the task may include the system executing a contact control policy, such as controlling joints of the robotic hand and/or robotic arm coupled to the robotic hand with closed loop control to move digits and other features of the robotic hand and/or arm to one or more positions based on the prediction, or to a plurality of positions based on the plurality of predictions, corresponding to the trajectory.

At operation 1010, the system may determine whether the task has been completed. If the task has not been completed (No), the process can return to operations 1004 to 1006 for a next time stamp. However, if the task has been completed (Yes), the process can return to operation 1002 for a next task to perform, which may be the same task again (e.g., grasping a next electrical connector and installing it at a next target in the electrical system) or a different task.

An aspect of the disclosure may include a non-transitory machine-readable medium (such as computer memory) having stored thereon instructions, which program one or more data processing components (generically referred to here as a “processor”) to (automatically) perform operations, as described herein. In other aspects, some of these operations might be performed by specific hardware components that contain hardwired logic. Those operations might alternatively be performed by any combination of programmed data processing components and fixed hardwired circuit components. A “processor” may include a distributed arrangement where multiple processors are configured and controlled to perform the recited operations or tasks together, e.g., one processor can perform some of the recited operations and another processor can perform others of the recited operations.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function.

In utilizing the various aspects of the embodiments, it would become apparent to one skilled in the art that combinations or variations of the above embodiments are possible for training robotic devices to perform tasks, which may be based on object-centric contact prediction modeling. Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration.

1. A system for training a robotic device to perform a task, comprising:
a glove to be worn by a user to perform a task with an object in a demonstration environment, the glove including digits having digit sections including a fingertip;
a sensor array coupled to the glove, the sensor array including i) tactile sensors arranged in sensor sections coupled to digit sections, including a sensor section coupled to the fingertip, the sensor section including a plurality of tactile sensors, each tactile sensor including circuitry to generate a digital output, and ii) motion sensors coupled to digits;
a camera to generate images of the object; and
a processor configured to:
receive current contact measurements from the sensor array, including tactile signals determined from tactile sensors and positions determined from motion sensors, the tactile signals including digital outputs from tactile sensors indicating an applied force;
receive a current pose of the object based on an image from the camera, the current pose including an orientation of the object in the demonstration environment; and
train a machine learning model, based on training data including the current contact measurements from the sensor array, and the current pose of the object from the image, corresponding to one another at a time stamp, to:
generate a prediction of future contact measurements of the sensor array, and a future pose of the object, corresponding to one another at a future time stamp, to control a robotic device to achieve the orientation of the object and the applied force in a robotic environment to perform the task with the object.

2. The system of claim 1, wherein the training data includes a plurality of data samples corresponding to a plurality of time stamps, each data sample including current contact measurements and a current pose.

3. The system of claim 2, wherein the plurality of data samples includes performance of a plurality of tasks.

4. The system of claim 2, wherein the plurality of data samples includes performance of one or more tasks with a plurality of objects.

5. The system of claim 2, wherein the plurality of data samples corresponds to human demonstration of the task.

6. The system of claim 2, wherein the processor is further configured to: generate a trajectory of future poses of the object based on a plurality of predictions corresponding to a plurality of time stamps.

7. The system of claim 1, wherein the current contact measurements represent a force distribution of the fingertip in the sensor array.

8. The system of claim 1, wherein the tactile signals indicate 3D force vectors corresponding to contact between sensor sections and the object, each 3D force vector comprising an aggregate of forces from tactile sensors of a sensor section.

9. The system of claim 1, wherein the positions indicate 3D positions of forces corresponding to contact between sensor sections and the object.

10. The system of claim 1, wherein the current pose includes a 3D position and a 3D orientation of the object relative to an environment of the object.

11. The system of claim 1, wherein the current pose is determined based on a segmentation of the object from the image.

12. The system of claim 1, wherein the current pose is determined based on a point cloud generated by an RGB-D image from the camera.

13. The system of claim 1, wherein the current pose is determined based on a fusion of images of the object, motion sensing, and the current contact measurements.

14. The system of claim 1, wherein the camera is coupled to the glove.

15. The system of claim 1, further comprising a microphone coupled to the glove, wherein the processor is further configured to:
receive at least one of: a command to start or end the task, an indication of a type of the task, or an input indicating a standard operating procedure for the task via the microphone.

16. The system of claim 1, wherein the machine learning model includes a neural network with supervised learning, interactive imitation learning, or reinforcement learning.

17. The system of claim 1, wherein the machine learning model enables a robotic controller to control a joint of a robotic hand to move to a position and the orientation based on the prediction.

18. A system for performing a task with an object, comprising:
a robotic hand to perform a task with an object in a robotic environment, the robotic hand including digits having digit sections including a digit having a fingertip;
a sensor array coupled to the robotic hand, the sensor array including i) tactile sensors arranged in sensor sections coupled to digit sections, including a sensor section coupled to the fingertip, the sensor section including a plurality of tactile sensors, each tactile sensor including circuitry to generate a digital output, and ii) motion sensors coupled to digits;
a camera to generate images of the object; and
a processor configured to:
receive current contact measurements from the sensor array, including tactile signals determined from tactile sensors and positions determined from motion sensors, the tactile signals including digital outputs from tactile sensors indicating an applied force;
receive a current pose of the object based on an image from the camera, the current pose including an orientation of the object in the robotic environment; and
generate, based on the current contact measurements from the sensor array, and the current pose of the object from the image, corresponding to one another at a time stamp, a prediction from a machine learning model of:
future contact measurements of the sensor array, and a future pose of the object, corresponding to one another at a future time stamp, to control the robotic hand to perform the task with the object.

19. The system of claim 18, wherein the prediction replicates an action of one of a plurality of tasks stored in a data structure.

20. The system of claim 18, wherein the robotic hand visually corresponds to a human hand and kinematically and dynamically performs like a human hand.

21. The system of claim 18, wherein the processor is further configured to:
control a joint of the robotic hand to move to a position and an the orientation based on the prediction.

22. The system of claim 18, further comprising:
a robotic arm coupled to the robotic hand, wherein the robotic arm is moved to a position and the orientation based on the prediction.

23. The system of claim 18, wherein the processor is further configured to: generate a trajectory of future poses of the object based on a plurality of predictions corresponding to a plurality of future time stamps.

24. The system of claim 18, wherein the current pose is determined based on a fusion of images of the object, motion sensing, and the current contact measurements.

25. The system of claim 18, wherein the tactile signals provide multimodal sensing.

26. The system of claim 18, wherein the machine learning model includes a neural network that implements a physics-based model, and the machine learning model is trained based on demonstration data collected from a sensing glove worn by a user to perform the task with the object in a demonstration environment.

27. The system of claim 1, wherein the prediction includes a position and the orientation of the object relative to a marker in the robotic environment.

28. A method for controlling a robotic device to perform a task, comprising:
receiving current contact measurements from a sensor array coupled to a robotic hand in a robotic environment, the robotic hand including digits having digit sections, including a fingertip, the sensor array including i) tactile sensors arranged in sensor sections coupled to digit sections, including a sensor section coupled to the fingertip, the sensor section including a plurality of tactile sensors, each tactile sensor including circuitry to generate a digital output, and ii) motion sensors coupled to digits, the current contact measurements including:
tactile signals determined from tactile sensors and positions determined from motion sensors, the tactile signals including digital outputs from tactile sensors indicating an applied force;
receiving a current pose of an object based on one or more images from a camera, the current pose including an orientation of the object in the robotic environment;
generating, based on the current contact measurements from the sensor array, and the current pose of the object from the one or more images, corresponding to one another at a time stamp, a prediction from a machine learning model, the prediction including:
future contact measurements of the sensor array, and a future pose of the object, corresponding to one another at a future time stamp, to control the robotic hand to perform a task with the object.

29. The method of claim 28, wherein the machine learning model is trained based on a demonstration data collected from a sensing glove worn by a user to perform the task with the object in a demonstration environment.

30. The method of claim 29, wherein the tactile signals indicate 3D force vectors corresponding to contact between sensor sections and the object, each 3D force vector comprising an aggregate of forces from tactile sensors of a sensor section, including a 3D force vector corresponding to contact between the fingertip and the object.
